(19) United States
(12) Patent Application Publication
(10) Pub. No.: US 2025/0085148 A1
(43) Pub. Date: Mar. 13, 2025

(54) MULTIPHASE FLOW METER FRAMEWORK

(71) Applicant: Schlumberger Technology Corporation, Sugar Land, TX (US)

(72) Inventors: Massimiliano Fiore, Singapore (SG); Kun Yang, Singapore (SG); Guillaume Jolivet, Clamart (FR); Alexandre Martins, Clamart (FR)

(21) Appl. No.: 18/696,033

(22) PCT Filed: Nov. 18, 2022
(86) PCT No.: PCT/US2022/050439

§ 371 Date: Mar. 27, 2024

(30) Foreign Application Priority Data
Nov. 19, 2021 (SG) 10202112879S

(51) Int. Cl. G01F 1/74; G01F 25/10

(52) U.S. Cl. CPC G01F 1/74; G01F 25/10

(57) ABSTRACT

A method can include receiving multiphase flow data via a multiphase flow meter during a flowback production period of a hydraulically fractured well that extends into a formation that includes formation fluid; determining one or more water properties during at least a portion of the flowback production period using the multiphase flow data and a predictive model; and, based on the determining, outputting values indicative of one or more of oil flow rate, gas flow rate, and water flow rate during the flowback production period.

### RELATED APPLICATION

This application claims priority to and the benefit of a Singapore Patent Application having Application No. 10202112879S, entitled “Prediction of Water Properties for Gamma-Ray-Absorption-Based Multiphase Flow Meters During the Frac Flowback Phase of Unconventional Shale Oil/Gas Wells” for Applicant Schlumberger Technology B.V., filed 19 Nov. 2021 with the Intellectual Property Office of Singapore, which is incorporated by reference herein in its entirety.

### BACKGROUND

A reservoir can be a subsurface formation that can be characterized at least in part by its porosity and/or fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.) and non-hydrocarbon fluids (e.g., water).

### SUMMARY

A method can include receiving multiphase flow data via a multiphase flow meter during a flowback production period of a hydraulically fractured well that extends into a formation that includes formation fluid; determining one or more water properties during at least a portion of the flowback production period using the multiphase flow data and a predictive model; and, based on the determining, outputting values indicative of one or more of oil flow rate, gas flow rate, and water flow rate during the flowback production period. As an example, a system can include a processor; memory accessible to the processor; processor-executable instructions stored in the memory and executable by the processor to instruct the system to: receive multiphase flow data via a multiphase flow meter during a flowback production period of a hydraulically fractured well that extends into a formation that includes formation fluid; perform a determination for one or more water properties during at least a portion of the flowback production period using the multiphase flow data and a predictive model; and, based on the determination, output values indicative of one or more of oil flow rate, gas flow rate, and water flow rate during the flowback production period. As an example, one or more computer-readable media can include computer-executable instructions executable by a system to instruct the system to: receive multiphase flow data via a multiphase flow meter during a flowback production period of a hydraulically fractured well that extends into a formation that includes formation fluid; perform a determination for one or more water properties during at least a portion of the flowback production period using the multiphase flow data and a predictive model; and, based on the determination, output values indicative of one or more of oil flow rate, gas flow rate, and water flow rate during the flowback production period. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of systems;

FIG. 3 illustrates an example of a system;

FIG. 4 illustrates an example of a system;

FIG. 5 illustrates examples of plots;

FIG. 6 illustrates an example of a plot and an example of a multiphase flow meter;

FIG. 7 illustrates an example of a plot;

FIG. 8 illustrates examples of plots;

FIG. 9 illustrates an example of a plot;

FIG. 10 illustrates an example of a graphical user interface;

FIG. 11 illustrates an example of a plot;

FIG. 12 illustrates an example of a surface production network;

FIG. 13 illustrates an example of a method and an example of a system; and

FIG. 14 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

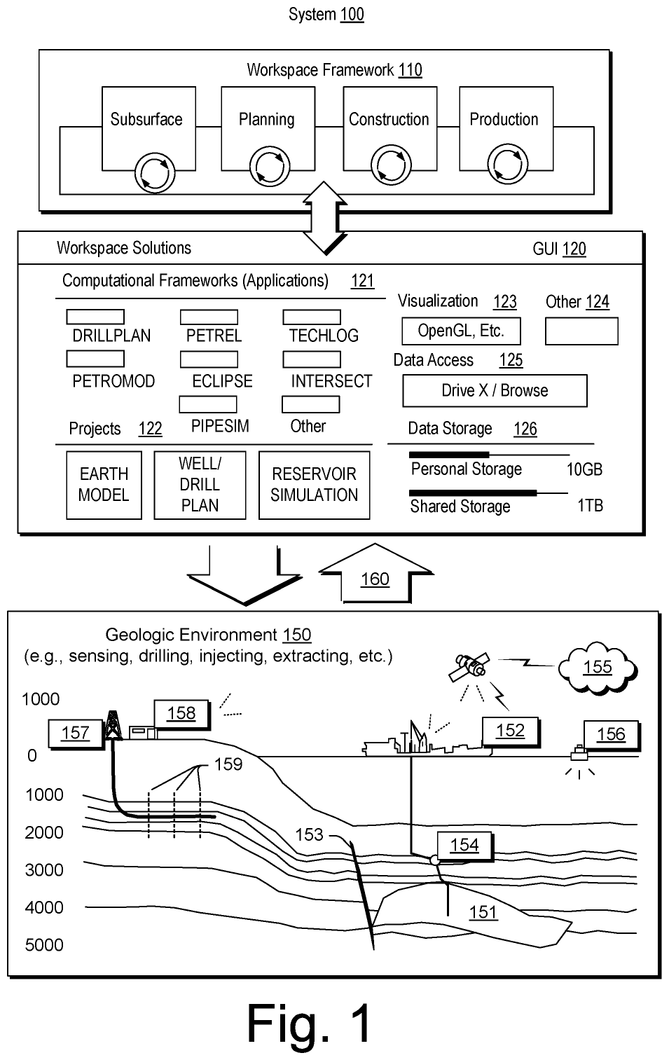

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, PIPESIM, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive E&P environment (SLB, Houston, Texas) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages. Examples of such software packages include the PETREL framework. As an example, a system or systems may utilize a framework such as the DELFI framework (SLB, Houston, Texas). Such a framework may operatively couple various other frameworks to provide for a multi-framework workspace. As an example, the GUI 120 of FIG. 1 may be a GUI of the DELFI framework.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such an approach can provide for compatibility of devices, frameworks, etc., with respect to one or more sets of instructions.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different productions scenarios to find an optimal one before production or further production occurs. A reservoir simulator does not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results too are to some extent uncertain. A process known as history matching can involve comparing simulation results to actual field data acquired during production of fluid from a field. Information gleaned from history matching, can provide for adjustments to a model, data, etc., which can help to increase accuracy of simulation.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the VISAGE geomechanics simulator (SLB, Houston Texas) or the PIPESIM network simulator (SLB, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena. The MANGROVE simulator (SLB, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

The PETREL framework provides components that allow for optimization of exploration and development operations. The PETREL framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes (e.g., with respect to one or more geologic environments, etc.). Such a framework may be considered an application (e.g., executable using one or more devices) and may be considered a data-driven application (e.g., where data is input for purposes of modeling, simulating, etc.).

As mentioned, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, etc.).

As an example, data can include geochemical data. For example, consider data acquired using X-ray fluorescence (XRF) technology, Fourier transform infrared spectroscopy (FTIR) technology and/or wireline geochemical technology.

As an example, one or more probes may be deployed in a bore via a wireline or wirelines and/or via a drillstring. As an example, a probe may emit energy and receive energy where such energy may be analyzed to help determine mineral composition of rock surrounding a bore. As an example, nuclear magnetic resonance may be implemented (e.g., via a wireline, downhole NMR probe, etc.), for example, to acquire data as to nuclear magnetic properties of elements in a formation (e.g., hydrogen, carbon, phosphorous, etc.).

As an example, lithology scanning technology may be employed to acquire and analyze data. For example, consider the LITHO SCANNER technology marketed by SLB (Houston, Texas). As an example, a LITHO SCANNER tool may be a gamma ray spectroscopy tool.

As an example, a tool may be positioned to acquire information in a portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the aforementioned TECHLOG framework (SLB, Houston, Texas).

As an example, a workflow may utilize one or more types of data for one or more processes (e.g., stratigraphic modeling, basin modeling, completion designs, drilling, production, injection, etc.). As an example, one or more tools may provide data that can be used in a workflow or workflows that may implement one or more frameworks (e.g., PETREL, TECHLOG, PETROMOD, ECLIPSE, etc.).

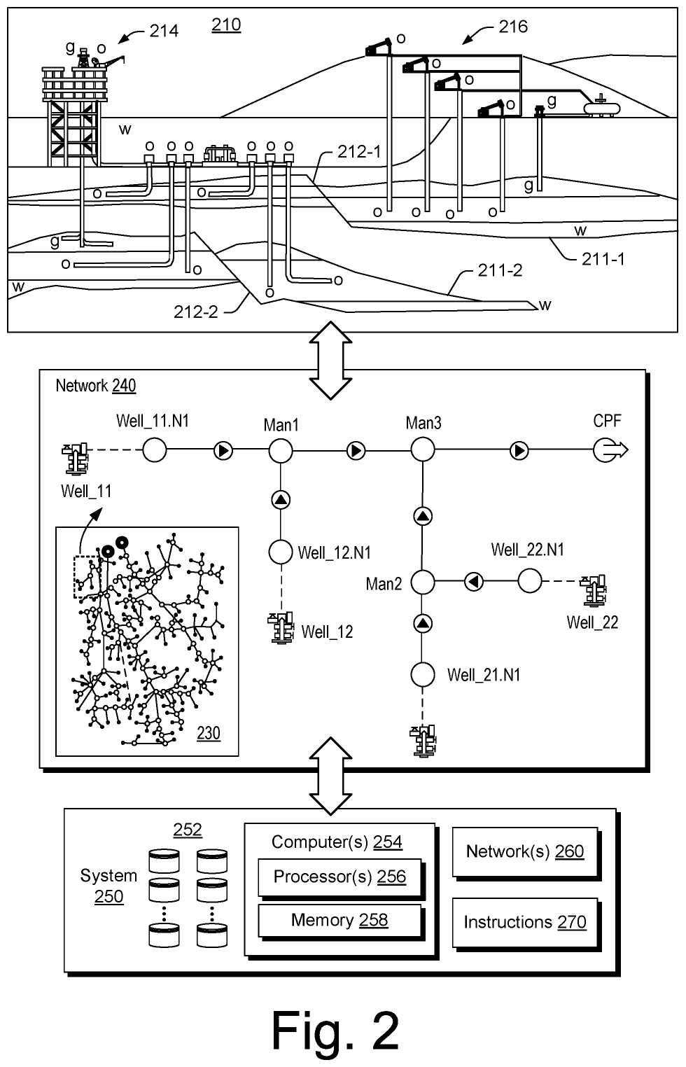

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1.

In the example of FIG. 2, the various equipment 214 and 216 can include drilling equipment, wireline equipment, production equipment, etc. For example, consider the equipment 214 as including a drilling rig that can drill into a formation to reach a reservoir target where a well can be completed for production of hydrocarbons. In such an example, one or more features of the system 100 of FIG. 1 may be utilized. For example, consider utilizing the DRILLPLAN framework to plan, execute, etc., one or more drilling operations.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of oil (o) and gas (g) fluids from well locations along flowlines interconnected at junctions with final delivery at a central processing facility.

In the example of FIG. 2, various portions of the network 240 may include conduit. For example, consider a perspective view of a geologic environment that includes two conduits which may be a conduit to a manifold Man1 and a conduit to Man3 in the network 240. A multiphase flowmeter (MPFM) may be installed at the flowline of each well (Well_11, Well_12, Well_22, etc.) to provide continuous production data of each well, for example, consider one or more of a gas flow rate, an oil flow rate and a water flowrate, for production allocation, production management, or for improved reservoir modeling (e.g., production history matching, forecasting).

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, well production data etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.). As an example, one or more methods, techniques, etc. may be performed using one or more sets of instructions, which may be, for example, the instructions 270 of FIG. 2.

As an example, a well can be disposed in an unconventional play. For example, consider the Bakken, Niobrara, Barnett, Eagle Ford, Haynesville, Marcellus or Monterey regions, which include unconventional shale reservoirs. Production of hydrocarbons from an unconventional play may be facilitated through hydraulic fracturing, which is a type of stimulation treatment.

Hydraulic fracturing may be implemented for oil and/or gas wells in low-permeability reservoirs in an effort to facilitate production. Hydraulic fracturing can utilize engineered fluids (e.g., stimulation treatment fluids) that can be pumped at high pressure and rate into a reservoir interval to be treated, causing, for example, a vertical fracture to open. A fracture can be formed in a formation as a pair of wings where the wings of the fracture extend away from a wellbore in opposing directions according to natural stresses within the formation. Proppant, such as grains of sand of a particular size, can be mixed with treatment fluid to keep the fracture open when the treatment is complete. Hydraulic fracturing tends to create high-conductivity communication with a relatively large area of a formation and can bypass damage that may exist in a near-wellbore area.

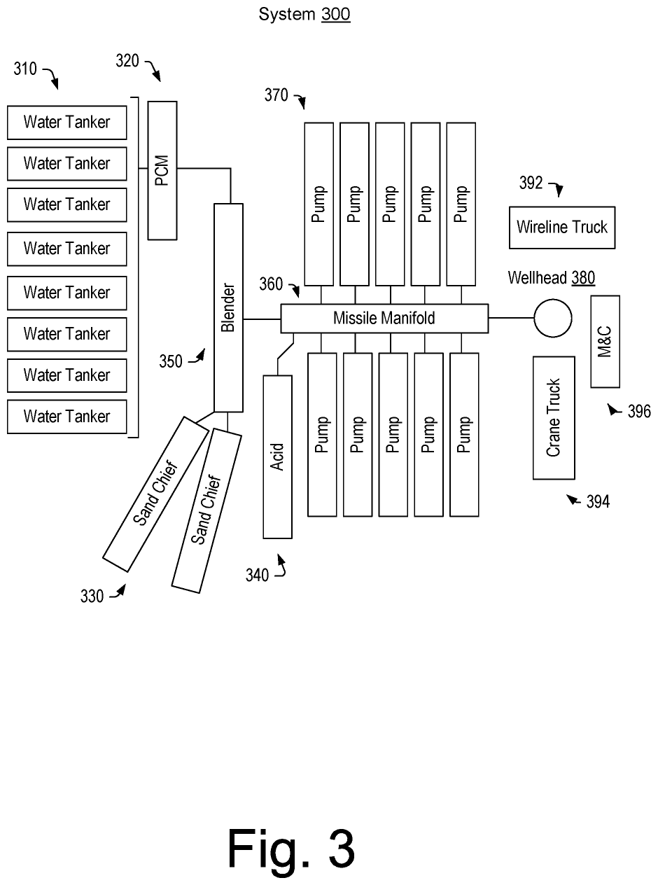

FIG. 3 shows an example of a system 300 that can be utilized to perform hydraulic fracturing. As shown, the system 300 can include water tankers 310, a precision continuous mixer (PCM) 320, one or more sand chiefs 330, an optional acid and/or other chemical supply 340, a blender 350, a missile manifold 360, and a fleet of pump systems 370. The pump systems 370 are operatively coupled to the missile manifold 360, which is supplied with fluid via at least the PCM 320 and the blender 350, which may receive fluid from one or more of the water tankers 310, which can include conduits operatively coupled via a manifold or manifolds. As shown, the system 300 can provide for output of blended fluid, optionally with solids (e.g., sand as proppant, etc.) and optionally with chemicals (e.g., surfactant, acid, etc.), to a wellhead, which is a wellhead 380 to at least a partially completed well (e.g., with one or more completion components). As an example, hydraulic fracturing can be performed using the system 300. At the wellhead 380, various types of equipment may be present such as a wireline truck 392, a crane truck 394 and monitoring and/or control (M&C) equipment 396.

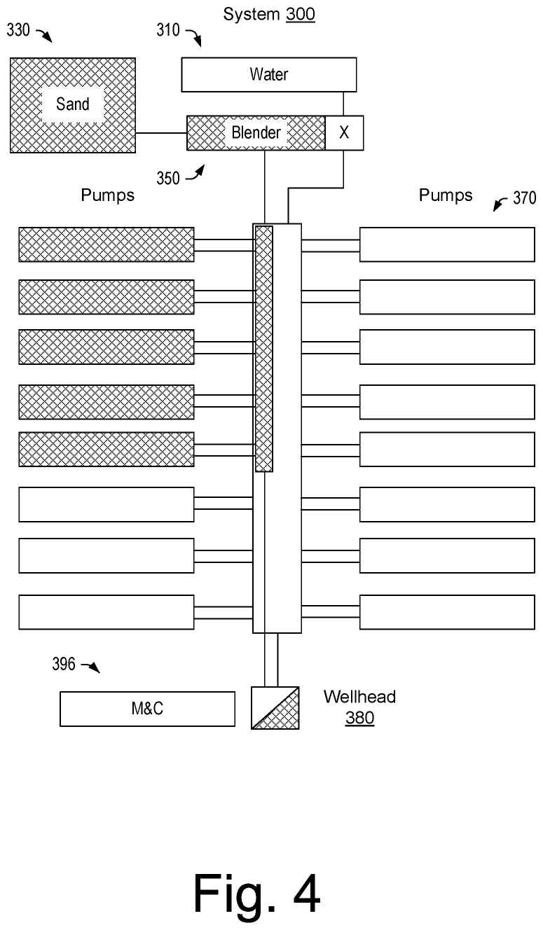

FIG. 4 shows another example of the system 300 that includes various pumps 370 (e.g., pump systems). As shown, the blender 350 can handle sand (e.g., proppant) as may be supplied by the one or more sand chiefs 330 and water as may be supplied by one or more water tankers 310 where the pumps 370 can direct a slurry to the wellhead 380.

FIGS. 3 and 4 show the monitoring and control equipment (M&C) 396, which may be or include equipment such as the FracCAT equipment (SLB, Houston, Texas). The FracCAT equipment (a fracturing computer-aided treatment system) includes hardware and software for monitoring, controlling, recording and reporting various types of fracturing treatments. Its real-time displays, plots, surface schematics and wellbore animations present information of a treatment as it occurs, which can provide for decision making using real-time detailed job information from the surface to the perforations. As an example, a framework such as the FracCADE framework (SLB, Houston, Texas) may be utilized, which includes various components for fracture design and evaluation. Such a framework may, for example, be integrated with or otherwise accessible via the DELFI environment.

During a job, M&C equipment can track job parameters, which may be compared to planned values. M&C equipment can use design specifications to control proppant and additive concentrations in one or more blenders. M&C equipment may be operatively coupled to a local area network (LAN) environment, for example, to allow for networking of equipment at a wellsite and provide a connection to the Internet (e.g., through satellite or cellular telephone technology). As an example, Internet connectivity can provide an ability to transmit real-time data from a wellsite to one or more locations (e.g., for real-time analysis, etc.).

As explained, various types of equipment can perform various types of field operations. As an example, a controller can be operatively coupled to one or more types of equipment.

As to hydraulic fracturing operations, such operations may utilize various components of the system 300 and/or one or more other components. As an example, a hydraulic fracturing operation can introduce a string or line into a cased bore of a well where the string or line carries a perforator. The perforator can include a distal end and charge positions associated with activatable charges that can perforate a casing and form channels in surrounding formation. Fluid may then be introduced into the bore between a heel and a toe where the fluid passes through the perforations in the casing and into the channels. Where such fluid is under pressure, the pressure may be sufficient to fracture the formation, for example, to form fractures, which may be first stage fractures, for example, of a multistage fracturing operation.

Additional operations can be performed for further fracturing of a formation. For example, a plug may be introduced into a bore between a heel and a toe and positioned, for example, in a region between first stage perforations of a casing and the heel. A perforator may be activated to form additional perforations in the casing (e.g., second stage perforations) as well as channels in the formation (e.g., second stage channels). Fluid may be introduced while the plug is disposed in the bore, for example, to isolate a portion of the bore such that fluid pressure may build to a level sufficient to form fractures in the formation (e.g., second stage fractures).

As to types of proppant, they can include naturally occurring sand grains, man-made or specially engineered particles such as, for example, resin-coated sand or high-strength ceramic materials like sintered bauxite. Proppant materials can be sorted for size and sphericity to provide an efficient conduit for production of fluid from a reservoir to a wellbore.

As to chemicals that may be considered for hydraulic fracturing operations, a chemical can include one or more of the OpenFRAC fluid family of chemicals (SLB, Houston, Texas). As an example, consider sodium chloride, magnesium chloride, amphoteric alkyl amine, calcium magnesium sodium phosphate, propan-2-ol, acrylamide copolymer, ammonium sulfate, sodium sulfate, potassium chloride, urea, hypochlorous acid, non-crystalline silica, dimethyl siloxanes, silicones, guar gum, hemicellulase (enzyme), boric acid, calcium chloride, etc.

As an example, a fluid can include one or more scale inhibitors that may act to reduce scaling of proppant. As an example, a fluid can provide for crosslinking, gel formation, linear gel formation, slickwater, etc. As an example, one or more chemicals can provide for drag reduction, load-water recovery, and/or formation stabilization. As an example, a chemical may provide for degradation of a component that is intended to be degraded during and/or after an operation (e.g., consider a degradable plug).

As an example, a fluid may be formulated to facility transport of proppant (e.g., propping agent) in a fracture, may be formulated to be compatible with formation rock and fluid, may be formulated to generate enough pressure drop along a fracture to create a fracture of a desired width, may be formulated to minimize friction pressure losses during injection, may be formulated using chemical additives that are approved according to local environmental regulations, may be formulated to exhibit controlled-break to a low-viscosity fluid for cleanup after treatment, and may be formulated as to cost-effectiveness.

As an example, viscosity of a fluid may be optimized via chemical composition. As an example, density of a fluid may be optimized via chemical composition. As an example, viscosity and density of a fluid may be optimized via chemical composition. In such examples, optimization can include modeling of a proppant pack and simulating one or more physical phenomena, which can include flow, temperature, reaction rate or rates of various reactions, etc.

As an example, a method may optimize chemistry based at least in part on a type of fracture to be generated. For example, low-viscosity fluids pumped at high rates may aim to generate narrow, complex fractures with low-concentrations of propping agent (e.g., about 0.2 to about 5 lbm proppant added (PPA) per gallon (e.g., about 24 g/l to about 600 g/l)).

To minimize risk of premature screenout, a pumping rate can be selected to transport proppant over a desired distance, which may be along a horizontal wellbores. For a wide-biwing fracture, fluid can be selected to be of a viscosity for suspension and transport of higher proppant concentrations. Such a treatment fluid may be pumped at a lower pump rate and may create wider fractures (e.g., about 0.5 cm to about 2.5 cm).

Fluid density can affect the surface injection pressure and the ability of the fluid to flow back after treatment. In low-pressure reservoirs, low-density fluids, like foam, can be used to assist in fluid cleanup. Conversely, in certain deep reservoirs (including offshore), higher density fracturing fluids may be utilized.

As explained, hydraulic fracturing can occur in stages involving drilling, plugging, and fracturing. In such an approach, there can be an increase in pressure and a backup of fluid while further stages are drilled. When the final stage is drilled, fluid may be allowed to flow up out of a well for a period of time, for example, up to about 2 months. That period of time may be referred to as the flow back or flowback period, where water returning from the well is made up partially of drilling fluid and injected hydraulic fracturing fluid, and formation brines that are entrapped in a target formation and extracted together with hydrocarbons. Water generated after the flowback period, during the lifetime of oil and gas production, may be referred to as produced water. The distinction between flowback and produced water definitions can be subjective when reporting data, and combined flowback and produced water (FP Water) data are reported in many instances without a specific distinction.

As an example, a system can provide for making determinations as to the volume and salinity of FP water generated through time. In such an example, water salinity data can be utilized to distinguish the contribution of naturally occurring formation brines relative to returned hydraulic fracturing fluid, which together generate FP water. As an example, hydraulic fracturing operations may be conducted with freshwater; noting that such operations may reuse FP water.

When using freshwater for hydraulic fracturing, the FP water initially has low salinity, yet mixing with formation brines tends to result in a rapid rise in the salinity of the water generated during the first several weeks of production and eventually leveling out to values that represent the maximum level of salinity of the formation brines, for example, consider a period of time between approximately 2 months and approximately 3 months post-hydraulic fracturing.

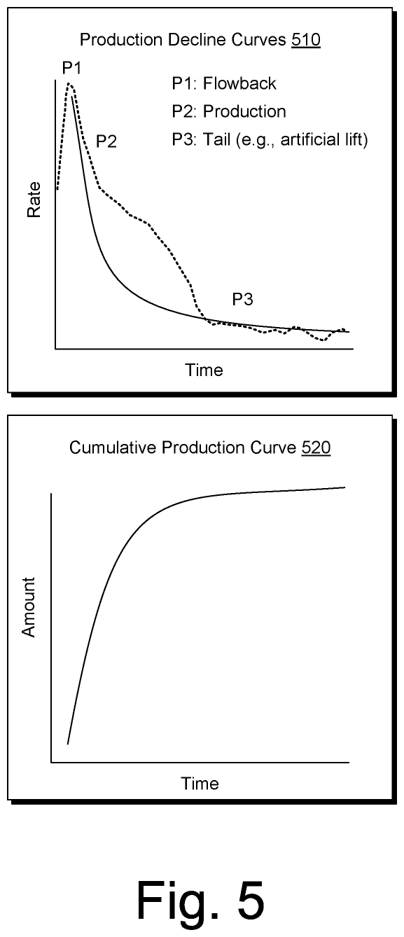

FIG. 5 shows examples of production decline curves (PDC) 510 and an example of a cumulative production curve (CPC) 520. As to the PDCs 510, a dashed line indicates a more realistic PDC that corresponds to an unconventional well where a the PDC can be characterized as including a flowback period (P1), a production period (P2) and an artificial lift period (P3) (e.g., a tail or long tail), which may be characterized by relatively high gas volume fraction (GVF) and relatively low production of liquid (PL).

A PDC may be part of a decline curve analysis (DCA) for analyzing declining production rates and forecasting future performance of oil and/or gas wells. Hydrocarbon production rates decline as a function of time where causes may be one or more of loss of reservoir pressure or changing relative volumes of produced multiphase fluid. Fitting a line through the performance history and assuming this same trend will continue in future forms the basis of DCA concept; however, in absence of stabilized production trends, DCA may be uncertain and/or inaccurate.

A DCA may utilize one or more techniques. For example, consider use of an exponential, a hyperbolic and/or a harmonic equation. An example equation is given below:

$$q ( t ) = ( {q}_{i} ) / [ {( 1 + b {D}_{i} t )}^{1 / b} ]$$

where a starting point on a y-axis, qᵢ, can be an initial rate, an initial decline rate is Dᵢ, and where a degree of curvature is b.

As an example, exponential decline can be for b=0 while one or more other types of decline may provide a value for b (e.g., 0 to 0.5); noting that hyperbolic cases occur for b=0 and b=1.

As indicated, DCA can depend on an initial rate, which may correspond to a particular point in time. For hydraulically fractured wells, as explained, some uncertainty may exist as to a transition from a flowback period to a production period. As an example, a system can provide for improved determinations as to one or more of such periods and, for example, a transition therebetween, which may be a point in time (e.g., or a particular window of time).

A factor that can complicate determinations as to one or more of various periods of flow can be a property or properties of water. For example, as explained, water can be used for hydraulic fracturing where the water may be sourced as freshwater. In contrast, water in a formation may be more saline. As an example, water can be characterized by its salinity. Salinity can be a measure of saltiness or amount of salt dissolved in water, which may have units of g/L or g/kg (grams of salt per liter/kilogram of water). Another measure is total dissolved solids (TDS), which is a measure of the dissolved combined content of inorganic and organic substances present in a liquid in molecular, ionized, or micro-granular (colloidal sol) suspended form. TDS concentrations may be reported in parts per million (ppm) or g/L. Yet another measure is total dissolved salts (TDSa), which is a measure of concentration of positively charged and negatively charged ions in water.

As an example, a system can include one or more types of multiphase flow meters. As an example, one or more types of multiphase flow meters (MPFMs) may depend on calibration where a calibration depends on water composition. For example, an MPFM may utilize multiple energy gamma ray absorption (MEGRA), which can include dual energy gamma ray absorption (DEGRA).

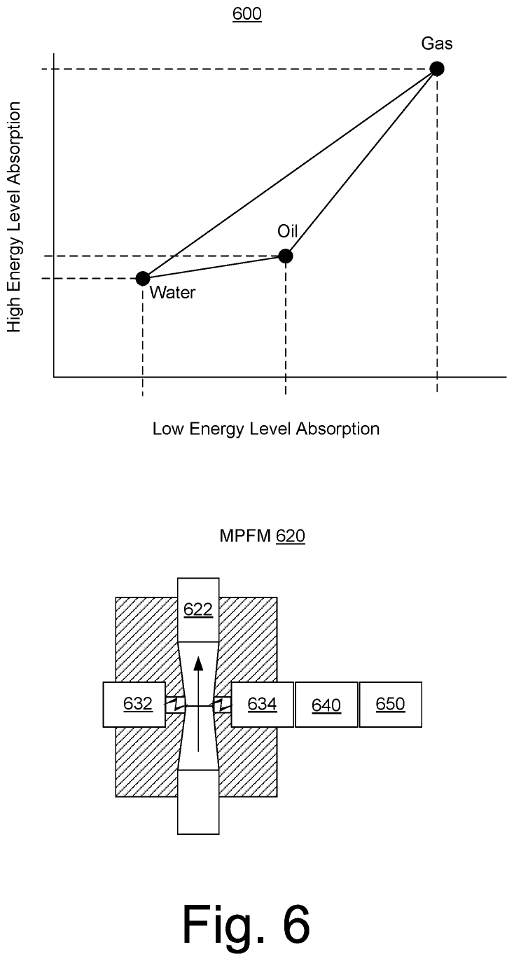

FIG. 6 shows an example plot 600 of data from a DEGRA system and an example schematic view of an MPFM 620 that can be a DEGRA system (e.g., or MEGRA system). In the example of FIG. 6, two energy levels can provide for different values that can be analyzed to determine percentage or fraction of oil, gas and water in a multiphase fluid. Specifically, in the plot 600, the points for oil, gas and water are reference points where a triangle defined by these points includes the possible combinations of oil, gas and water fractions along a gamma ray beam path of a DEGRA system. In the plot 600, the axes show the linear attenuation coefficients of the two energy levels where a point inside the triangle represents particular phase fractions of oil, gas and water. By combining a multiphase fluid fraction measurement by the DEGRA with a Venturi differential pressure measurement, the total mass flowrate of the multiphase fluid, and hence the three phase oil, water and gas flowrate measurement results are obtained.

As shown, the MPFM 620 can include a Venturi conduit 622, a gamma ray radioactive source 632, a detector 634, a processor 640 with associated memory and an interface 650, which may be a wired and/or a wireless network interface (e.g., network interface circuitry). As shown by an arrow, fluid can flow in the Venturi conduit 622 while emissions from the gamma ray sources 632 interact with the fluid in the throat section of the Venturi conduit 622 and where at least partial emissions can be detected by the detector 634. The processor 640 can be operatively coupled to the source 632 and the detector 634 for purposes of control and signal processing. As an example, the processor 640 may include one or more features of a framework that can make one or more model-based adjustments to measurements of the MPFM 620, for example, consider adjustments that can account for changes in one or more water properties (e.g. salinity, etc.) during a flowback period of a well. As an example, the interface 650 may output data that can be processed by a framework that can make one or more model-based adjustments to measurements of the MPFM 620, for example, consider adjustments that can account for changes in one or more water properties during a flowback period of a well. In such an example, the framework can be a local framework and/or a remote framework. Such a framework can be a computational framework that can include one or more interfaces for receipt of information and/or output of information.

Referring to the example network 240 of FIG. 2, one or more of the wells and/or other equipment (e.g., manifolds, etc.) may be instrumented with one or more MPFMs. Referring to the examples of FIG. 3 and FIG. 4, the wellhead 380 and/or a conduit (e.g., pipe, etc.) in fluid communication with the wellhead 380 may be instrumented with one or more MPFMs. In such examples, an MPFM may take measurements during at least a portion of a flowback period, which is considered to be a production period. As illustrated in the example of FIG. 5, the periods P1 and P2 periods may be referred to as flowback production periods.

As an example, a system can include one or more multiphase flow meters (MPFMs), which may be installed permanently and/or on an as-desired basis. As an example, an MPFM can include one or more features of the Vx SPECTRA surface multiphase flow meter (SLB, Houston, Texas). Such a flow meter can utilize a spectrum analysis to accurately measure oil, gas, and water flow rates without phase separation. Such a single flow meter may be transported from location to location to acquire various MPFM measurements.

The Vx SPECTRA flow meter includes a venturi section and a multivariable transmitter and associated circuitry for measuring differential pressure, pressure and temperature to measure total flow rate; a nuclear source and detector that obtain oil, gas, and water holdups; and a compact flow computer that performs computations and converts flow measurements from line to standard conditions. The Vx SPECTRA flow meter uses full-gamma spectroscopy to accurately capture multiphase flow dynamics for real-time monitoring and analysis.

The Vx SPECTRA flow meter can include an embedded computer running a real time operating system that can handle data from instrumentation of the flow meter. The embedded computer can run an interpretation model and handle external communications. The embedded computer can provide for adjusting one or more parameters that may be calibration parameters.

A flow meter can include a radioactive source such as, for example, a ₁₃₃Ba radioactive source. Such a flow meter can include pressure barriers made of extremely hard ceramic to support line pressure but also transparent to the ₁₃₃Ba radiation path across the Venturi throat. A source capsule can be installed in a source holder, shielded with tungsten, which can be an external source shielding made of tungsten where a stainless steel source holder contains a small capsule of ₁₃₃Ba.

An MPFM can include various components, which may be physical hardware components such as pressure, differential pressure and temperature sensors, associated multi-variable transmitter components, radioactive source and detector components, flow computer components, etc. As an example, an MPFM can include one or more models, which may include model parameters. As an example, one or more types of parameters (e.g., physical, electrical, firmware, software, etc.) may be adjustable for purposes of calibration of an MPFM.

As an example, a field can include multiple sites where multiple, for example more than 60 MPFMs are installed. Operators can obtain continuous and reliable flow rates from a plurality of MPFMs permanently installed on wells or manifolds (connected to multiple wells). MPFMs may require recalibration with marked change in operational parameters and composition (e.g. water salinity) of production fluids. As an example, an operator can be provided with a pre-defined calibration program with a fixed frequency of calibration operations for each MPFM (e.g., 2 to 4 months). In some cases, changes in fluid properties (e.g., in salinity) may be so rapid during a flow back production period, such that an untimely calibration to adjust for changes in salinity may result in a large measurement error in water cut, and in individual phase flow rates.

A method that can help to optimize a calibration schedule may result in an operational cost reduction of 20 percent or more, by minimizing the number of manual water sampling and calibration interventions at an MPFM site. Further, such a method can improve data quality, decision making and control, reduce unnecessary carbon emissions, and HSE risk.

As mentioned, MEGRA measurement can depend on gamma ray attenuation and hence density of a component of a multiphase fluid. As explained, a well may experience a flowback period prior to a production period where one or more properties of water may change. For example, water during the flowback period may be less saline than water during a production period.

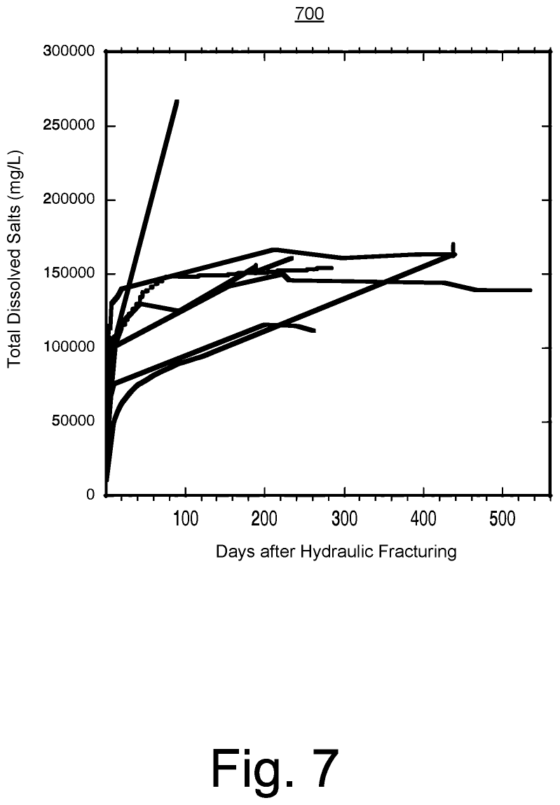

FIG. 7 shows an example plot 700 of TDSa in mg/L versus days after hydraulic fracturing for various wells. As shown, the TDSa can increase with respect to time and may level off after some period of time to a relatively constant level, which can correspond to a reservoir formation water salinity value.

As explained, an MPFM can depend on calibrations where, for example, water utilized for calibration is of a particular property, which may be a particular salinity or density or salinity and density. As shown in the plot 700, as water salinity can change with respect to time, a water calibration value may become stale, which can result in a lack of accuracy of output of an MPFM.

To address changes in one or more water properties, a method can include automatically updating a water calibration of an MPFM with respect to time in a data-based manner. In such an example, well data may be acquired that can be processed to determine one or more trends in one or more water properties. Such an approach can include model building where a model may be tuned to a particular field or portion thereof using data. In such an example, the model may be integrated into an MPFM and/or otherwise operatively coupled to an MPFM. For example, consider integration into circuitry of an MPFM, coupling to circuitry at a well site and/or coupling via remote circuitry, which may be cloud-based or otherwise remote from a well site. As an example, raw MPFM data, such as MEGRA data, can be processed and adjusted according to a model. As an example, a model may be an empirical model or a physics-based model. As an example, a model may be a machine learning model (an ML model).

As an example, a system can provide for prediction of water properties for one or more gamma ray absorption-based MPFMs, for example, during a frac flowback production phase of one or more unconventional shale oil/gas wells. Such a system can implement a method to predict the temporal evolution of water properties (e.g., salinity, density, etc.) during a frac flowback production phase of one or more unconventional shale oil/gas wells.

As explained, an MPFM can include components to make measurements based on absorption of gamma rays with multiple energies, which may be affected by changes in chemical compositions of production fluid from fluid used during commissioning (e.g., hydraulic fracturing fluid, etc.). As explained, in a frac flowback stage of shale oil and gas production, the salinity of the produced water can change rapidly (see, e.g., the plot 700 of FIG. 7). Such a change can be due to the initial production (recovery) of the injected fluid used in high-pressure hydraulic fracturing, based on low-salinity water, transitioning to the production of formation water generally with a higher salinity. In various instances, such a process can be characterized by a rapid increase of water salinity during the first two to four weeks of production, followed by a further slower increase, leveling off toward the formation salinity, which can last several months.

A water salinity increase leads to changes in water density and mass attenuation coefficients, thus affecting the output of an MPFM based on absorption of gamma rays, commissioned based on the properties of the water produced at the beginning of production. Further, the impact on MPFM metrology performance due to salinity change tends to be more pronounced for high water-liquid ratio (WLR), water-continuous multiphase flows.

As explained, to help guarantee reliable phase flow rate measurements, a method can provide for processing MPFM data in a real-time manner to address water salinity changes under multiphase conditions. As an example, a method can be processor-based and optionally operable without additional input from a sensor (e.g., a dedicated sensor for water salinity).

As an example, a system can help to reduce costs, which can be beneficial in view of fluctuating oil prices and consequent shale-oil/gas field operation economics faced by unconventional well operators, who may be reluctant to invest in one or more additional sensors at each well site.

As an example, a system can leverage a mix between available data of shale oil/gas wells and direct measurements of a well being monitored. As explained, a system can utilize one or more models for predicting temporal evolution of water properties, for example, during a frac flowback production period to help guarantee accurate flow rate measurements from one or more MPFMs that utilize gamma ray absorption.

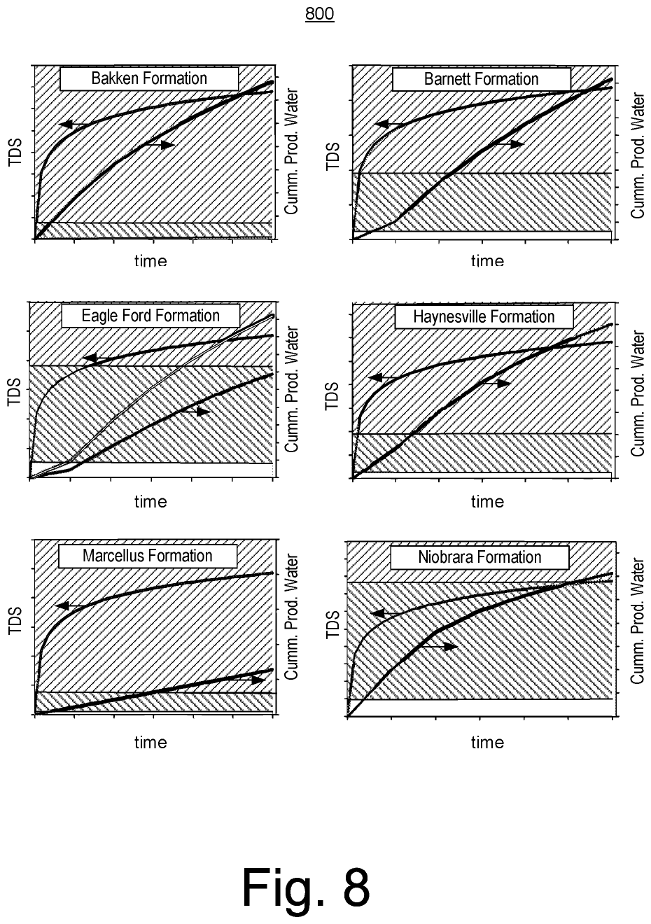

FIG. 8 shows example plots 800 from different formations where each of the plots includes a curve for water salinity and a curve for cumulative water production through the first 6 months of oil and gas production as interpolated using percentage values multiplied by final production TDS. In the plot for the Eagle Ford formation, a white curve shows water for oil a curve below shows water for gas. In the plots 800, the regions represent a classification of water as brackish (white, approx. 5000 mg/L TDS) saline (cross-hatching lower right to upper left, 5000-33,000 mg/L TDS), and hypersaline brine (cross-hatching lower left to upper right, >33,000 mg/L TDS). The plots 800 show, for frac flowback production, a similar evolution of the salinity in produced water.

As shown, a relatively rapid salinity increase can be followed by a slower increase eventually levelling off towards salinity from formation fluid. As an example, such an evolution of salinity can be modeled by one or more functions such as, for example, a piece-wise linear (with square root of time) function, a saturation function, a Fickian diffusion models, etc.

As an example, field operations may utilize, for one or more frac flowback production periods, one or more initial models that may be adjusted over time, for example, according to direct measurements of one or more properties of sampled produced water. For example, consider density and/or temperature measurements of sampled produced water. In such an example, measurements may be utilized to adjust one or more models, which may be or include one or more initial models and/or one or more already adjusted models. As an example, a method may proceed without salinity measurements. For example, a system may implement a method that can utilize a calibrated MPFM where the method adjusts output of the MPFM without resorting to acquiring salinity measurements. In such an example, the calibrated MPFM may have been calibrated using salinity measurements from a sensor (e.g., onsite salinity sensor) where the sensor is not further utilized and/or not present during a frac flowback production period (e.g., after frac flowback has commenced).

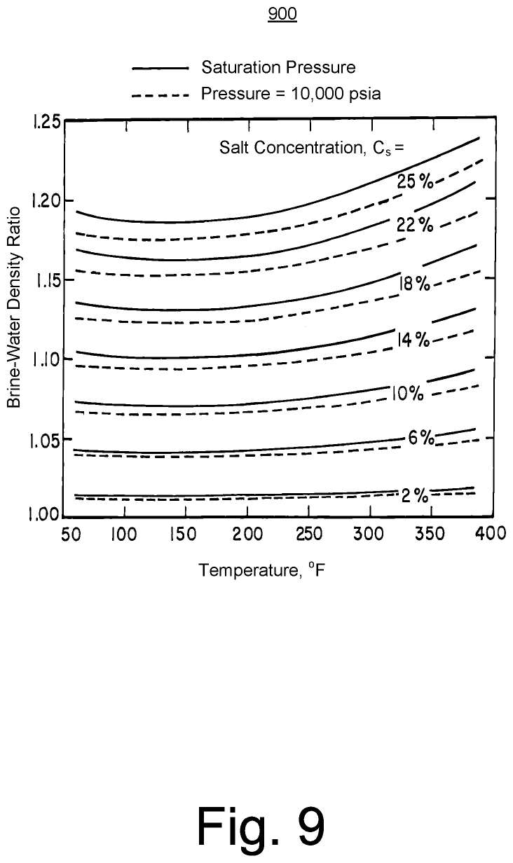

FIG. 9 shows an example plot 900 of brine relative density (ρₛ/ρ_{w}, ranging from 1.00 to 1.25) versus temperature (50 degrees F. to 400 degrees F.) and pressure (saturation pressure to 10,000 psia) for various salt concentrations (Cₛ).

As an example, an approach set forth in an article by Rowe and Chou (A. M. Rowe, and J. C. S. Chou, Pressure-Volume-Temperature-Concentration Relation of Aqueous NaCl Solutions, Journal of Chemical and Engineering Data, 15 (1970), 61-66), which is incorporated by reference herein, may be utilized. Rowe and Chou fit data to an empirical equation as follows:

$$1 / {ρ}_{s} = A ( T ) - B ( T ) p - C ( T ) {p}^{2} + D ( T ) {C}_{s} + E ( T ) {C}_{s}^{2} - F ( T ) {C}_{s} p - G ( T ) {C}_{s}^{2} p - H ( T ) {C}_{s} {p}^{2}$$

where ρₛ is the specific density of brine (g/cc), p is pressure in psia, T is temperature in degrees Fahrenheit, Cₛ is salt concentration in percent, and the terms A(T), B(T), C(T), D(T), E(T), F(T), G(T) and H(T) are coefficients that are functions of temperature.

As an example, when a water sample is prepared, density can be directly measured; with an assumption that NaCl is the dominant salt species dissolved in the water where the water salinity can be calculated with a correlation such as, for example, the foregoing equation of Rowe and Chou.

As an example, a model may be a dynamic model that can be adjusted with respect to time during a frac flowback production period of a well using measurements (e.g., data), which may include measurements of fluid from the well and/or measurements of fluid from one or more neighboring wells (e.g., a well or wells from a common pad, an adjacent pad, etc.). As explained, measurements may be density and/or temperature measurements; noting that one or more types of pressure measurements may be utilized.

To minimize demand for measurement points and to obtain models from data fit accurately to describe temporal evolution of one or more water properties (e.g., salinity, density, etc.), a model may utilize a function that can be advantageously driven by a minimum number of free parameters to be optimized.

To help guarantee a meaningful fit, the number of data m to be fit to a model can be substantially larger than the number of free parameters p to be optimized. In other words, the degree of freedom ν=m−p>>1; this number can be maximized by both maximizing m and minimizing p. As an example, a method may aim to limit, as much as possible or practicable, field engineer interventions to obtain water samples at a well site. Consider: if m will be only advantageously optimized (i.e., increased), p shall be minimized. As an example, a saturation model may be utilized with a limited number of free parameters. For example, consider a saturation model with up to three free parameters as a candidate for modelling the evolution of one or more water properties (e.g., salinity, density, etc.).

As an example, the following dynamic saturation model may be utilized:

$$y = {y}_{s} \frac{Δ t}{k + Δ t} + {y}_{0} \qquad ( 1 )$$

where Δt is the time elapsed from the beginning of flowback production; y is the quantity to be predicted over time; y₀ is the initial value at the beginning of flowback production of the quantity to be predicted; yₛ is the difference between the saturation (maximum) and initial (y₀) values of the quantity to be predicted; and k is the “curvature” of the function.

The parameters in the model of equation (1) may be optimized for a best fit of available data where the parameters optimized include: y₀, k and/or yₛ.

For MPFMs based on gamma ray absorptions, a framework can include multiple models. For example, consider three models predicting the temporal evolution of: i) water salinity and/or water density, ii) mass attenuation coefficient for low energy X-rays or gamma rays, and iii) mass attenuation coefficient for high energy X-rays or gamma rays.

As an example, when a water sample is prepared, density and temperature can be directly measured; with the assumption that NaCl is the dominant salt species dissolved in the water. As explained, water salinity may be calculated with a correlation such as in the article by Rowe and Chou. Where three saturation models are utilized, each one of the three saturation models may be fully described by the values of the three parameters y₀, k and yₛ.

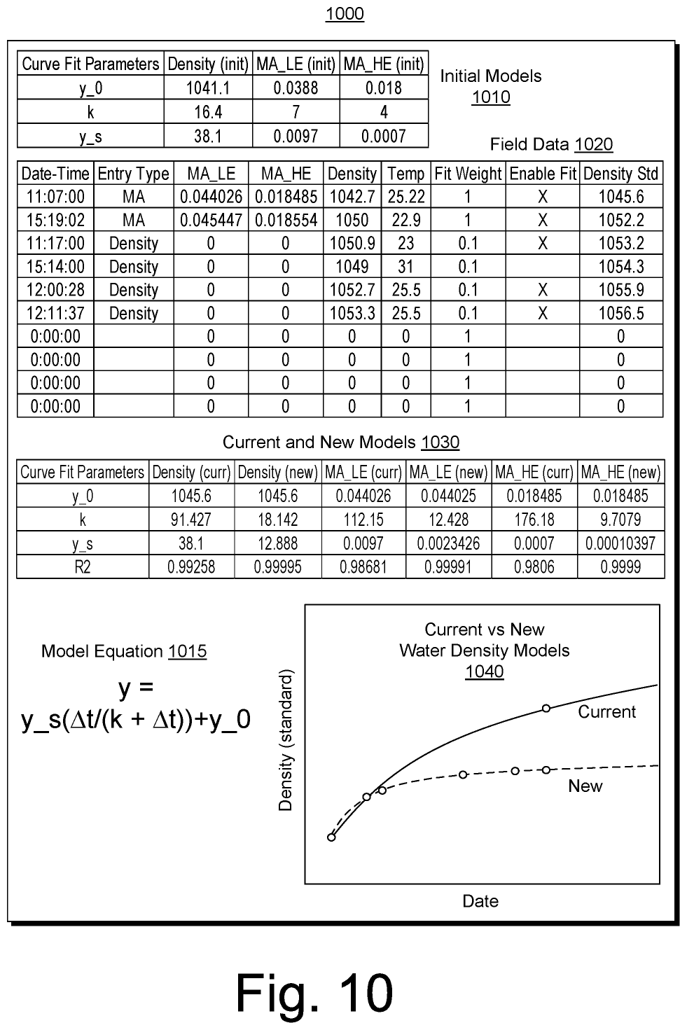

FIG. 10 shows an example of a graphical user interface (GUI) 1000 that can include various graphical controls. As shown, the GUI 1000 can include various fields that may be arranged as tables along with one or more plots and, for example, a panel for rendering a model or models. In the example of FIG. 10, the GUI 1000 includes an Initial Models table 1010 for curve fit parameters (e.g., model fit parameters) for density, mass attenuation for low energy (MA_LE) and mass attenuation for high energy (MA_HE). Hence, the example of FIG. 10 includes three models where, for example, each of the three models may utilize a common equation with three parameters (see, e.g., the model 1015).

In the example of FIG. 10, the GUI 1000 also includes a Field Data table 1020 where an entry type may be selected (e.g., using a drop-down menu, etc.) to specify various values. As shown, the table 1020 includes entries for date-time, MA_LE, MA_HE, density, temperature, fit weight, enabling fit and density (standard). As shown, the GUI 1000 can include a current and new models table 1030, which includes entries for curve fit parameters, density (current), density (new), MA_LE (current), MA_LE (new), MA_HE (current), and MA_HE (new).

As mentioned, the GUI 1000 shows the example model equation 1015 as rendered in a panel that is adjacent to a plot panel 1040 that can render current and new water density models and/or one or more other models (e.g., water salinity models, MA models, etc.). The GUI 1000 can be generated as part of a framework and utilized for water property prediction (e.g., based on water salinity).

As explained, a framework can provide for rendering an Initial Models table, for example, for displaying the values for the three fit parameters for the three models predicting the evolution of: i) water salinity, ii) low-energy mass attenuation coefficient of water (MA_LE), and iii) high-energy mass attenuation coefficient of water (MA_HE).

As explained, a framework can provide for rendering a Field Data table, for example, to be populated with direct measurements of water properties such as: density and temperature or, for example, more complete water mass attenuation coefficients, and including density and temperature measurements of the water sample. As explained, date and time of each measurement can be entered into appropriate table fields. As an example, elapsed time Δt from the beginning of flowback production may be automatically calculated from the date and time entered in a field data table.

As an example, a framework can provide for rendering a GUI where a user can specify a weight given to each measurement, for example, by entering a value in a Fit Weight table field. In such an example, values can be used as weights by a fitting process. As an example, weights for density and temperature measurements may have a lower weight. As an example, when two mass attenuation coefficients are not directly measured, they may be computed from water salinity change at a time t with respect to a well opening time t₀, Δs(t)=s(t)−s(t₀), as follows:

$${μ}_{w , E} ( t ) = {μ}_{w , E} ( {t}_{0} ) + Δ s ( t ) \cdot [ {μ}_{NaCl , E} - {μ}_{H 2 O , E} ] \qquad ( 2 )$$

where E stands for either LE or HE, μ_{NaCl} is the mass attenuation coefficient of sodium chloride, μ_{H2O} is the mass attenuation coefficient of fresh water.

As explained, an assumption may be utilized that NaCl is the sole or dominant (e.g., greater than 90 percent of TDS) salt species dissolved in produced water. A direct mass attenuation coefficient measurement can guarantee reliable values to adjust the mass attenuation coefficient models.

As shown in the example GUI 1000 of FIG. 10, the Field Data table 1020 can include an Enable Fit graphical control that may be toggled on and off. In such an example, a user can decide whether to include or exclude measurement points by ticking or unticking the corresponding box in an Enable Fit column.

As explained, a framework can provide for rendering a current and new models table, which may display current and potentially new values of fitting parameters each time measurement points are included/excluded to/from the fitting process.

As explained, a framework can provide for rendering a plot of current versus new models, which may help a user to decide whether to accept the new model from the current one being adjusted. As explained with respect to the example GUI 1000 of FIG. 10, a water density plot is shown, noting that one or more other types of plots (e.g., model plots) may be rendered. As an example, a GUI may include multiple plot panels for rendering various model results (e.g., current, new, old, etc.).

As to a fitting process, one or more types of nonlinear modeling processes may be utilized. For example, consider a nonlinear (weighted) least squares method; as an example, the Levenberg-Marquardt method may be utilized as part of a fitting process for the example model equation 1015 of the example of FIG. 10.

As an example, to reduce the risk of unphysical values of fit parameters, while mathematically accurate, one or more minimum bound values may be used for y₀, corresponding to the salinity (or density) and mass attenuation coefficients for fresh water. As an example, a maximum bound value may correspond to the salinity or density (and mass attenuation coefficients) of the prevalent formation water (for example, obtained from local reservoir-formation knowledge, or from downhole formation water samples, or from a downhole tool capable of determining formation water resistivity, conductivity, or density). As an example, formation water salinity may be limited such that it does not exceed a salt saturation level.

As explained, one or more measurements may be acquired during a flowback production period from one or more wells. As an example, for measurements being added over time during a frac flowback production period, a method can include performing fit parameter optimization. For example, as to the model equation (1), consider the following rules: (1) up to two measurements: y₀ is optimized as free parameter; (2) three measurements: y₀ and k are updated as free parameters; and (3) four or more measurements: fit parameters y₀, k and yₛ are updated as free parameters. In such an approach, when a single measurement is available, the models can be forced to include measured data and, from two measurements onwards, at least one degree of freedom for the fitting process can be guaranteed, which can lead to predictive models adjusted to the evolution of a monitored well (or wells).

As an example, a method can include acquiring data from a number of wells from a formation (e.g., a horizon or a basin) that are successfully mapped during a frac flowback production phase. In such an example, average models for the formation can be derived from optimized fit parameters of the wells. In such an example, the average models can be employed for one or more new wells extending into the same formation, which can involve optimizing, for instance, using a starting value y₀ and relying on similar water property evolutions (e.g., consider keeping values frozen for k and yₛ). Such an approach can allow for taking into account changes of water properties during frac flowback production, to adjust accordingly phase fractions measured through gamma ray absorption and consequently flow rates of a multiphase mixture, while minimizing the number of manual water sampling interventions at an MPFM site. As explained, the model equation (1) is an example where one or more other types of equations may be utilized for saturation models over time.

As explained, phase fraction measurements in a gamma ray absorption-based MPFM can be based on attenuation of photons with at least two different energies after interaction with water-oil-gas multiphase flow. The attenuation of photons by a medium tends to obey the Beer-Lambert law

$$n = {n}_{0} exp ( - λ d ) \qquad ( 3 )$$

where n and n₀ are the number of photons transmitted per second after interaction and incident to the medium, respectively; λ is the linear attenuation coefficient, which depends on the incident photon energy and the medium, and defined as the probability for the photons to be adsorbed or scattered; d is the medium thickness, equivalent to the photon-medium interaction distance.

As explained with respect to the example of FIG. 6, at least two photon energies can be used and properly selected to have enough contrast between λ_{w}, λₒ and λ_{g}, linear attenuation coefficients of the water, oil and gas, respectively, expected to be produced by a monitored well. Given the linearity of the linear attenuation coefficient with the mixture phase fraction, the mixture linear attenuation coefficient reads λₘ=α_{w}λ_{w}+αₒλₒ+α_{g}λ_{g}, where a represents the fraction of the phases in the mixture. Knowing that a pipe is filled by a water-oil-gas mixture (e.g., Σ_{i=w,o,g}αᵢ=1), the unknown phase fractions can be determined by solving the following system of linear equations:

$$\{ \begin{matrix}{n}_{L E} = {n}_{0 , L E} exp ( - {\sum }_{i = w , o , g} {α}_{i} {λ}_{i , L E} \cdot d ) \\ {n}_{H E} = {n}_{0 , H E} exp ( - {\sum }_{i = w , o , g} {α}_{i} {λ}_{i , H E} \cdot d ) \\ {\sum }_{i = w , o , g} {α}_{i} = 1\end{matrix} \qquad ( 4 )$$

Prior to MPFM normal operations of real-time phase-fraction measurement, the linear attenuation coefficients of the water, oil and gas produced by the monitored well can be measured. For example, consider performing in-situ gamma ray absorption measurements by using static monophasic samples of the produced fluids. As explained, during frac flowback production, produced water λ_{w,E}=ρ_{w}·μ_{w,E} tends to continuously change due to an increase in dissolved salinity (e.g., from fracturing fluid to reservoir fluid). Hence, with a framework for model-based adjustments, an operator has to make manual modifications using new produced water points, which demands time-consuming manual operations. Such manual interventions can be particularly challenging, time-consuming, and/or costly for flow meters in remote locations and at sites that tend to operate without humans present. As explained, a framework can utilize one or more predictive models that can automatically provide predictions as to produced water property evolution (e.g., evolution of salinity, density, etc.), which can be utilized to update produced water linear attenuation coefficients at two energy levels E=(LE, HE) which are now time-dependent and read:

$${λ}_{w , E} ( t ) = {ρ}_{w} ( t ) \cdot {μ}_{w , E} ( t ) \qquad ( 5 )$$

where ρ_{w}(t), μ_{w,LE}(t) and μ_{w,HE}(t) can be computed using three predictive models.

As to frequency of updates, a framework may operate on a relatively continuous manner with respect to time. For example, consider updating on a minute-by-minute basis, noting that lesser or more frequent updating may be implemented. In various instances, updating may be continuous (e.g., constantly updating).

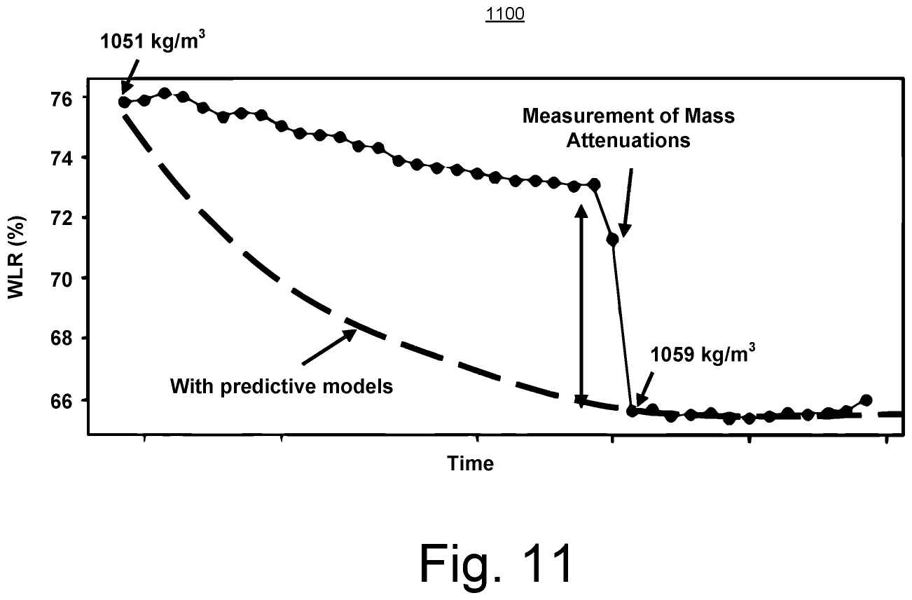

FIG. 11 shows an example plot 1100 of water-liquid ratio (WLR=α_{w}/α_{w}+αₒ) temporal evolution from raw MPFM measurements (circles) and from the produced water property predictive models. The large salinity change (with water-density change being from 1051 to 1059 kg/m³) during the first three weeks of frac flowback production is demonstrated by the WLR overestimation from the MPFM, which is adjusted properly once a direct measurement of mass attenuation coefficients from produced water samples is performed (see time corresponding to approximately the value of 1059 kg/m³). As explained, acquiring such data can be time consuming and logistically challenging. In the example of FIG. 11, the dashed curve is accurate and representative of actual conditions. As explained, such a curve can be achieved using predictive models.

In the example of FIG. 11, the WLR evolution of water-continuous multiphase flow is for a WLR that is greater than 60 percent during frac flowback production. Such relatively high WLR values can be of a particularly high measurement sensitivity to changes in salinity, hence highlighting benefits in predicting salinity change to maintain the accuracy in monitoring and/or estimating production of hydrocarbons. In the example of FIG. 11, the plot 1100 provides a comparison between raw MPFM measurements with one manual brine density correction via water sampling (circles) and after automatic correction with one or more water properties (e.g., salinity, density, etc.) predictive models (dashed curve).

As example, a framework can be implemented to improve MPFM performance through the use of model-based prediction for temporally evolving water properties according to frac flowback production data and direct water-sample measurements, optionally without installation or usage of one or more additional sensors. Such a framework can extend the applicability and increase the acceptance of gamma ray based MPFMs (e.g., from a time of beginning of frac flowback production of unconventional wells).

As explained, a framework can help to minimize manual water sample interventions at an MPFM site, which can reduce HSE risk and reduce use of and reliance on operational personnel.

As explained, a framework may operate locally and/or remotely to update of water properties via predictive models. As an example, an updated water density value may be communicated by a field operator for one or more remotely monitored wells.

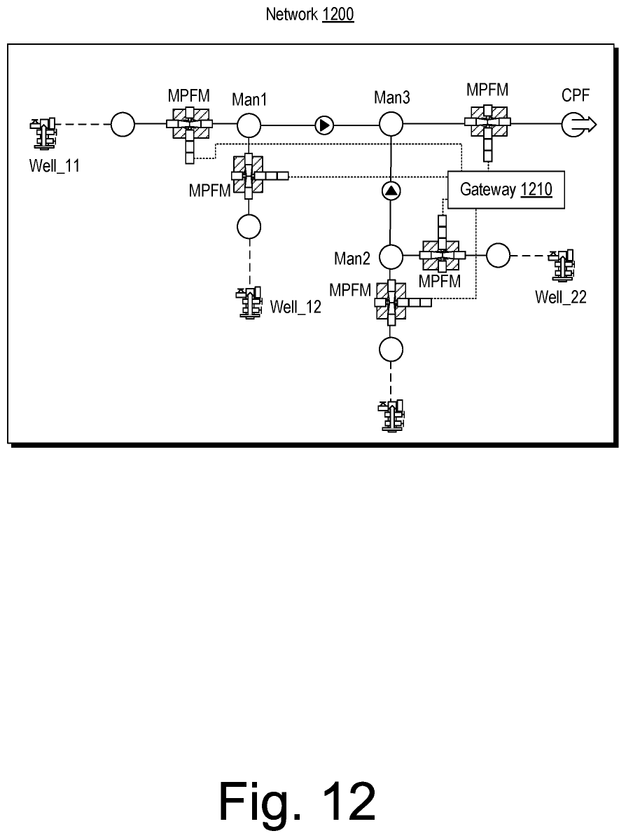

FIG. 12 shows an example of a surface production network 1200 that includes various wells and one or more MPFMs that may be operatively coupled to a gateway 1210. As an example, the gateway 1210 may include one or more features of an AGORA gateway (e.g., v.202, v.402, etc.) and/or another gateway. For example, consider features such as an INTEL ATOM E3930 or E3950 dual core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS or another operating system). As an example, a gateway may include a cellular interface (e.g., 4G LTE with global modem/GPS, 5G, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in (e.g., 25 cm×20.3 cm×10.1 cm). As an example, a framework or a portion thereof may be operable using a gateway.

As an example, a system, a method, etc., can utilize one or more types of ML models (e.g., predictive, etc.). As to examples of some types of ML models, consider one or more of a support vector machine (SVM) model, a k-nearest neighbors (KNN) model, an ensemble classifier model, a neural network (NN) model, etc. As an example, an ML model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, an ML model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train an ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, image classification, object detection, pose estimation, question answering, text classification, etc., on multiple platforms.

As an example, one or more ML models may be utilized for purposes of predicting. For example, consider one or more ML models that can provide for predicting water composition and/or water properties during a flowback production period. As an example, a gateway such as, for example, the gateway 1210 of FIG. 12, may be utilized to implement a framework. As an example, a gateway may be configured to include a framework. As an example, a gateway may include multiple frameworks where, for example, a framework may be or include an ML framework (e.g., consider the TFL framework).

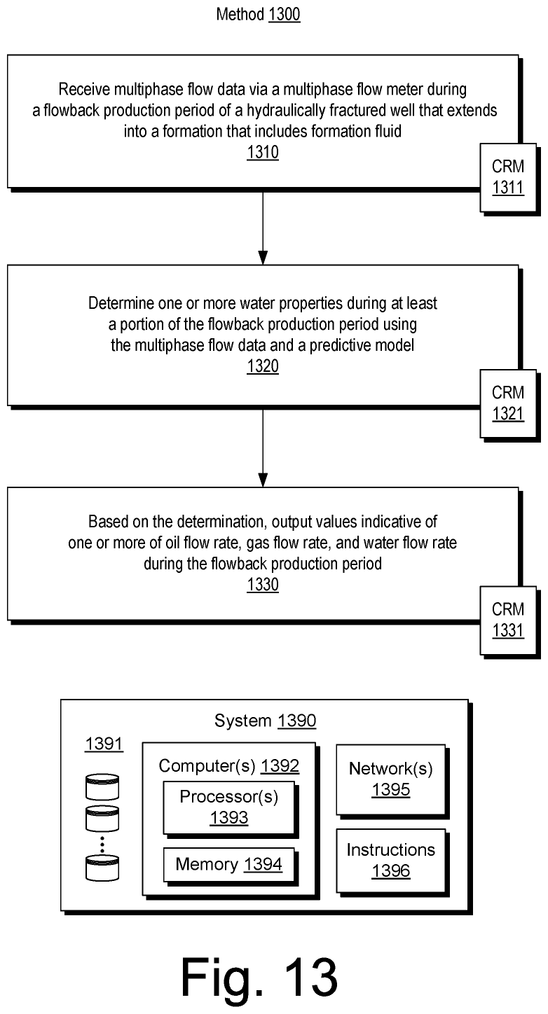

FIG. 13 shows an example of a method 1300 and an example of a system 1390. As shown, the method 1300 can a reception block 1310 for receiving multiphase flow data via a multiphase flow meter during a flowback production period of a hydraulically fractured well that extends into a formation that includes formation fluid; a determination block 1320 for determining one or more water properties during at least a portion of the flowback production period using the multiphase flow data a predictive model; and an output block 1330 for, based on the determining, outputting values indicative of one or more of oil flow rate, gas flow rate, and water flow rate during the flowback production period.

In the example of FIG. 13, the system 1390 includes one or more information storage devices 1391, one or more computers 1392, one or more networks 1395 and instructions 1396. As to the one or more computers 1392, each computer may include one or more processors (e.g., or processing cores) 1393 and memory 1394 for storing the instructions 1396, for example, executable by at least one of the one or more processors. As an example, a computer may include one or more network interfaces (e.g., wired or wireless), one or more graphics cards, a display interface (e.g., wired or wireless), etc.

The method 1300 is shown along with various computer-readable media blocks 1311, 1321 and 1331 (e.g., CRM blocks). Such blocks may be utilized to perform one or more actions of the method 1300. For example, consider the system 1390 of FIG. 13 and the instructions 1396, which may include instructions of one or more of the CRM blocks 1311, 1321 and 1331.

As an example, a method can include receiving multiphase flow data via a multiphase flow meter during a flowback production period of a hydraulically fractured well that extends into a formation that includes formation fluid; determining one or more water properties during at least a portion of the flowback production period using the multiphase flow data and a predictive model; and, based on the determining, outputting values indicative of one or more of oil flow rate, gas flow rate, and water flow rate during the flowback production period. In such an example, the water salinity can increase with respect to time toward a formation water salinity of the formation fluid during the flowback production period.

As an example, a method can include receiving data from a water sample taken during a flowback production period and adjusting a predictive model using the data. In such an example, the data from the water sample can include water density data and temperature data and one or more water properties can include one or more of water salinity and water mass attenuations.

As an example, a predictive model can be an ML model or a parametric model that includes one or more parameters. As an example, a method can include adjusting a predictive model by fitting parameters to data acquired from at least one water sample collected from a hydraulically fractured well or collected from a well proximate to the hydraulically fractured well that is in fluid communication with a common formation. In such an example, fitting can determine parameter values for the parameters.

As an example, a method can include acquiring water property data for one or more water properties during a flowback production period and adjusting at least one parameter of a predictive model using at least a portion of the water property data.

As an example, a predictive model can include a plurality of parameters where values for the parameters are determined by fitting the predictive model to data from a number of water samples taken during a flowback production period. In such an example, the number of water samples can be more than the number of parameters. As an example, a predictive model can be a three parameter model where, for example, data from a number of water samples may be utilized to determine values for the three parameters of the predictive model.

As an example, a method can include guaranteeing at least one degree of freedom to provide a meaningful fit for parameters of a predictive model where, after such a fit, data from one or more additional water samples may be acquired. In such an example, a method can consider trade-offs between accuracy and time spent to visit a wellsite to acquire water samples (e.g., water sample data).

As an example, multiphase flow can include water, oil and gas. In such an example, water flow rate, oil flow rate and gas flow rates may be determined.

As an example, a multiphase flow meter can emit at least two incident gamma ray energy levels. In such an example, a predictive model can account for water mass attenuations at the at least two incident gamma ray energy levels where the water mass attenuations depend on one or more of water density and water salinity.

As an example, a multiphase flow meter can include a processor where processing, such as, for example, determining one or more water properties, can be performed by the processor (e.g., using a predictive model, etc., and multiphase flow data).

As an example, a multiphase flow meter can include an interface that transmits multiphase flow data and wherein the determining is performed by a processor that is separate from the multiphase flow meter that receives the transmitted multiphase flow data.

As an example, a method can include outputting one or more of water-liquid ratio, water salinity, and water density with respect to time.

As an example, a method can include initializing a multiphase flow meter, where initializing can include determining multiple gamma ray energy absorptions for an oil phase, a water phase and a gas phase. In such an example, the initializing may occur prior to determining one or more water properties. In such an example, the determining can operate without using further initialization measurements for the multiphase flow meter as to gamma ray energy absorptions.

As an example, a system can include a processor; memory accessible to the processor; processor-executable instructions stored in the memory and executable by the processor to instruct the system to: receive multiphase flow data via a multiphase flow meter during a flowback production period of a hydraulically fractured well that extends into a formation that includes formation fluid; perform a determination for one or more water properties during at least a portion of the flowback production period using the multiphase flow data and a predictive model; and, based on the determination, output values indicative of one or more of oil flow rate, gas flow rate, and water flow rate during the flowback production period.

As an example, one or more computer-readable media can include computer-executable instructions executable by a system to instruct the system to: receive multiphase flow data via a multiphase flow meter during a flowback production period of a hydraulically fractured well that extends into a formation that includes formation fluid; perform a determination for one or more water properties during at least a portion of the flowback production period using the multiphase flow data and a predictive model; and, based on the determination, output values indicative of one or more of oil flow rate, gas flow rate, and water flow rate during the flowback production period.

As an example, a computer program product can include one or more computer-readable storage media that can include processor-executable instructions to instruct a computing system to perform one or more methods and/or one or more portions of a method.

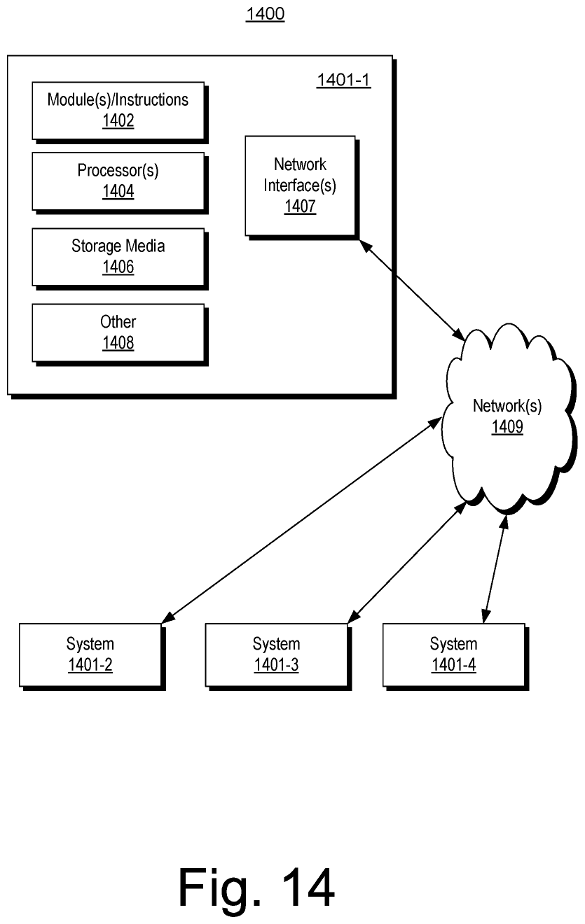

In some embodiments, a method or methods may be executed by a computing system. FIG. 14 shows an example of a system 1400 that can include one or more computing systems 1401-1, 1401-2, 1401-3 and 1401-4, which may be operatively coupled via one or more networks 1409, which may include wired and/or wireless networks. As shown, one or more other components 1408 may be included in the system 1400.

As an example, a system can include an individual computer system or an arrangement of distributed computer systems. In the example of FIG. 14, the computer system 1401-1 can include one or more modules 1402, which may be or include processor-executable instructions, for example, executable to perform various tasks (e.g., receiving information, requesting information, processing information, simulation, outputting information, etc.).

As an example, a module may be executed independently, or in coordination with, one or more processors 1404, which is (or are) operatively coupled to one or more storage media 1406 (e.g., via wire, wirelessly, etc.). As an example, one or more of the one or more processors 1404 can be operatively coupled to at least one of one or more network interface 1407. In such an example, the computer system 1401-1 can transmit and/or receive information, for example, via the one or more networks 1409 (e.g., consider one or more of the Internet, a private network, a cellular network, a satellite network, etc.).

As an example, the computer system 1401-1 may receive from and/or transmit information to one or more other devices, which may be or include, for example, one or more of the computer systems 1401-2, etc. A device may be located in a physical location that differs from that of the computer system 1401-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1406 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

### SOME DOCUMENTS INCORPORATED BY REFERENCE HEREIN IN THEIR ENTIRETY

A. J. Kondash, E. Albright, and A. Vengosh, Quantity of flowback and produced waters from unconventional oil and gas exploration, Science of the Total Environment 574 (2017) 314-321.
C.-G. Xie, G. Segeral, G. Roux, and P. Hammond, Methods and Apparatus for Estimating On-line Water Conductivity of Multiphase Mixtures, U.S. Pat. No. 6,831,470 B2, published 14 Dec. 2004.
M. Fiore, C.-G. Xie, and G. Jolivet, Extending Salinity Operating Range and Water Detection Lower Limit of Multiphase Flowmeters, International Petroleum Technology Conference 2020, IPTC-19590.
A. M. Rowe, and J. C. S. Chou, Pressure-Volume-Temperature-Concentration Relation of Aqueous NaCl Solutions, Journal of Chemical and Engineering Data, 15 (1970), 61-66.

What is claimed is:

1. A method comprising:
receiving multiphase flow data via a multiphase flow meter during a flowback production period of a hydraulically fractured well that extends into a formation that comprises formation fluid;
determining one or more water properties during at least a portion of the flowback production period using the multiphase flow data and a predictive model; and
based on the determining, outputting values indicative of one or more of oil flow rate, gas flow rate, and water flow rate during the flowback production period.

2. The method of claim 1, wherein water salinity increases with respect to time toward a formation water salinity of the formation fluid during the flowback production period.

3. The method of claim 1, comprising receiving data from a water sample taken during the flowback production period and adjusting the predictive model using the data.

4. The method of claim 3, wherein the data from the water sample comprises water density data and temperature data and wherein the one or more water properties comprise one or more of water salinity and water mass attenuations.

5. The method of claim 1, wherein the predictive model comprises parameters.

6. The method of claim 5, comprising adjusting the predictive model by fitting the parameters to data acquired from at least one water sample collected from the hydraulically fractured well or collected from a well proximate to the hydraulically fractured well that is in fluid communication with the formation.

7. The method of claim 6, wherein the fitting determines parameter values for the parameters.

8. The method of claim 5, comprising acquiring water property data for one or more of the one or more water properties during the flowback production period and adjusting at least one of the parameters using at least a portion of the water property data.

9. The method of claim 1, wherein the predictive model comprises a plurality of parameters and wherein values for the parameters are determined by fitting the predictive model to data from a number of water samples taken during the flowback production period.

10. The method of claim 9, wherein the number of water samples is more than the number of parameters.

11. The method of claim 1, wherein the multiphase flow comprises water, oil and gas.

12. The method of claim 1, wherein the multiphase flow meter emits at least two incident gamma ray energy levels.

13. The method of claim 12, wherein the predictive model accounts for water mass attenuations at the at least two incident gamma ray energy levels wherein the water mass attenuations depend on one or more of water density and water salinity.

14. The method of claim 1, wherein the multiphase flow meter comprises a processor and wherein the determining is performed by the processor.

15. The method of claim 1, wherein the multiphase flow meter comprises an interface that transmits the multiphase flow data and wherein the determining is performed by a processor that is separate from the multiphase flow meter that receives the transmitted multiphase flow data.

16. The method of claim 1, wherein the outputting comprises outputting one or more of water-liquid ratio, water salinity, and water density with respect to time.

17. The method of claim 1, comprising initializing the multiphase flow meter, wherein initializing comprises determining multiple gamma ray energy absorptions for an oil phase, a water phase, and a gas phase.

18. The method of claim 17, wherein the determining operates without using further initialization measurements for the multiphase flow meter as to gamma ray energy absorptions.

19. A system comprising:
a processor;
memory accessible to the processor;
processor-executable instructions stored in the memory and executable by the processor to instruct the system to:
receive multiphase flow data via a multiphase flow meter during a flowback production period of a hydraulically fractured well that extends into a formation that comprises formation fluid;
perform a determination for one or more water properties during at least a portion of the flowback production period using the multiphase flow data and a predictive model; and
based on the determination, output values indicative of one or more of oil flow rate, gas flow rate, and water flow rate during the flowback production period.

20. One or more computer-readable media comprising computer-executable instructions executable by a system to instruct the system to:
receive multiphase flow data via a multiphase flow meter during a flowback production period of a hydraulically fractured well that extends into a formation that comprises formation fluid;
perform a determination for one or more water properties during at least a portion of the flowback production period using the multiphase flow data and a predictive model; and
based on the determination, output values indicative of one or more of oil flow rate, gas flow rate, and water flow rate during the flowback production period.
